(19) United States
(12) Patent Application Publication
(10) Pub. No.: US 2022/0143971 A1
(43) Pub. Date: May 12, 2022

(54) DROPLET DISCHARGE APPARATUS AND CORRECTION METHOD

(71) Applicant: Kenji Maruoka, Kanagawa (JP)

(72) Inventor: Kenji Maruoka, Kanagawa (JP)

(73) Assignee: Ricoh Company, Ltd., Tokyo (JP)

(21) Appl. No.: 17/453,226

(22) Filed: Nov. 2, 2021

(30) Foreign Application Priority Data
Nov. 9, 2020 (JP) 2020-186778

(51) Int. Cl. B41J 2/045

(52) U.S. Cl. CPC B41J 2/04505; B41J 2/04581

(57) ABSTRACT

A droplet discharge apparatus includes a control device, a discharge device, and a measuring device. The control device sets conditions for a recording medium or a process using droplets. The discharge device discharges the droplets onto the recording medium. The measuring device measures landing positions of the droplets on the recording medium. The control device calculates a correction amount based on the landing positions, stores the correction amount for each of the conditions, and correct a timing at which the discharge device performs discharge with correction amounts that match the conditions, to correct the landing positions.

### CROSS-REFERENCE TO RELATED APPLICATION

This patent application is based on and claims priority pursuant to 35 U.S.C. § 119(a) to Japanese Patent Application No. 2020-186778, filed on Nov. 9, 2020, in the Japan Patent Office, the entire disclosure of which is incorporated by reference herein.

### BACKGROUND

### Technical Field

Embodiments of the present disclosure relate to a droplet discharge apparatus and a correction method.

### Related Art

In the related art, a technology is known in which a droplet discharge apparatus of an inkjet system corrects a deviation in landing positions of droplets.

Specifically, first, the droplet discharge apparatus discharges liquid droplets to print a test chart including a test pattern. Next, the droplet discharge apparatus reads the test pattern. Through this reading, the droplet discharge apparatus calculates a landing position deviation for an overlapping portion or the like in a head, based on image data obtained from a result of reading the test pattern. In this manner, the droplet discharge apparatus grasps the landing position deviation. The droplet discharge apparatus determines whether to correct the landing positions of droplets between nozzle rows in the head. As a result of this determination, when correction is performed, the droplet discharge apparatus calculates a correction value in the overlapping portion or the like and adjusts the landing positions between heads of the same color. There is known a technology of correcting the landing positions as described above to prevent local unevenness, streaks, and the like occurring at a joint.

### SUMMARY

According to an embodiment of the present invention, there is provided a droplet discharge apparatus that includes a control device, a discharge device, and a measuring device. The control device sets conditions for a recording medium or a process using droplets. The discharge device discharges the droplets onto the recording medium. The measuring device measures landing positions of the droplets on the recording medium. The control device calculates a correction amount based on the landing positions, stores the correction amount for each of the conditions, and correct a timing at which the discharge device performs discharge with correction amounts that match the conditions, to correct the landing positions.

According to another embodiment of the present invention, there is provided a correction method to be performed by a droplet discharge apparatus. The correction method includes setting, discharging, measuring. calculating, storing, and correcting. The setting sets conditions for a recording medium or a process using droplets. The discharging discharges the droplets onto the recording medium. The measuring measures landing positions of the droplets on the recording medium. The calculating calculates a correction amount based on the landing positions. The storing stores the correction amount for each of the conditions. The correcting corrects a timing of discharging the droplets with correction amounts that match the conditions, to correct the landing positions.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a diagram illustrating an overall configuration of an image forming system according to an embodiment of the present disclosure;

FIG. 2 is a diagram illustrating a configuration of detecting the position of a conveyed object using an image sensor, according to an embodiment of the present disclosure;

FIG. 3 is a diagram illustrating a hardware configuration of a droplet discharge apparatus, according to an embodiment of the present disclosure;

FIG. 4 is a diagram illustrating overall processing according to an embodiment of the present disclosure;

FIG. 5 is a diagram illustrating a functional configuration according to an embodiment of the present disclosure;

FIG. 6 is a diagram illustrating an example of correction based on an encoder signal, according to an embodiment of the present disclosure; and

FIG. 7 is a diagram illustrating a comparative example.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

Hereinafter, embodiments of the present disclosure will be described with reference to the drawings.

Overall Configuration

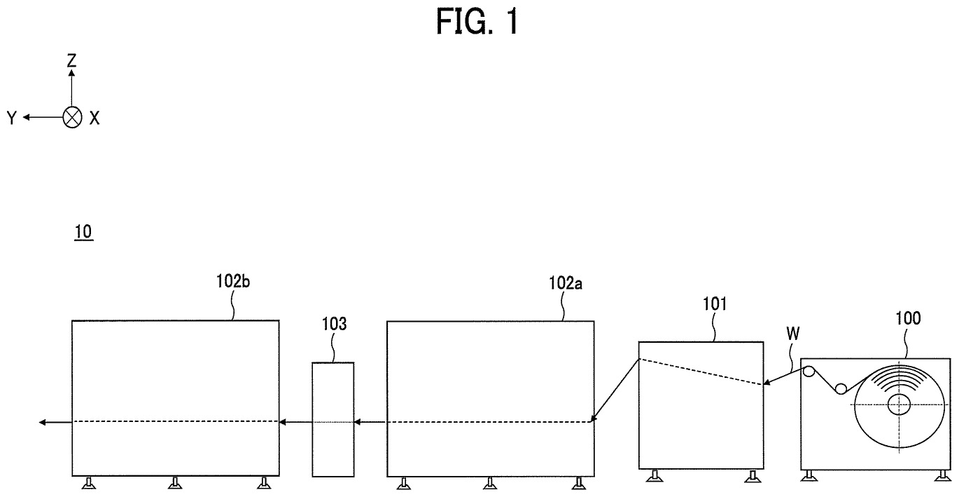

FIG. 1 is a diagram illustrating an overall configuration of an image forming system according to an embodiment of the present disclosure. Hereinafter, an example in which a sheet W is used as a recording medium will be described. For example, a droplet discharge apparatus according to the present embodiment is, for example, a first inkjet printer 102a included in the image forming system 10 described below. The following example is an example in which droplets are ink or the like and a droplet discharge apparatus discharges droplets to perform image formation.

In the following example, it is assumed that the sheet W is conveyed from right to left in FIG. 1. In the following description, the direction in which the sheet W is conveyed (hereinafter, simply referred to as a “conveyance direction”) may be referred to as a “Y direction”. On the other hand, the conveyance direction, that is, a direction perpendicular to the surface of the sheet W (the vertical direction in FIG. 1) may be referred to as a “Z direction”.

In the present embodiment, the width direction of the sheet W is referred to as an “X direction”. Furthermore, the following description is of an example in which heads are arranged in the X direction.

For example, the image forming system 10 includes a sheet feeding apparatus 100, a treatment-liquid applying apparatus 101, a first inkjet printer 102a, a reversing apparatus 103, and a second inkjet printer 102b. The first inkjet printer 102a and the second inkjet printer 102b are examples of droplet discharge apparatuses.

As described above, the recording medium is, for example, a roll sheet of paper.

The sheet feeding apparatus 100 conveys a sheet W to the treatment-liquid applying apparatus 101.

The treatment-liquid applying apparatus 101 performs pretreatment on the sheet W. For example, the treatment-liquid applying apparatus 101 applies treatment liquid to the front and back sides of the sheet W.

The first inkjet printer 102a discharges droplets of ink or the like onto the sheet W to form an image on the sheet W. For example, the first inkjet printer 102a forms an image according to image data on the surface of the sheet W.

The reversing apparatus 103 reverses the front and back sides of the sheet W.

The second inkjet printer 102b discharges droplets of ink or the like onto the sheet W to form an image on the sheet W. For example, the second inkjet printer 102b forms an image according to image data on the back side of the sheet W.

Note that the image forming system 10 is not limited to the configuration illustrated in FIG. 1. For example, the image forming system 10 may further include an apparatus that performs pre-treatment or post-processing other than the types illustrated in FIG. 1. The image forming system 10 may include one droplet discharge apparatus or three or more droplet discharge apparatuses.

Configuration Example of Detecting Position of Conveyed Object

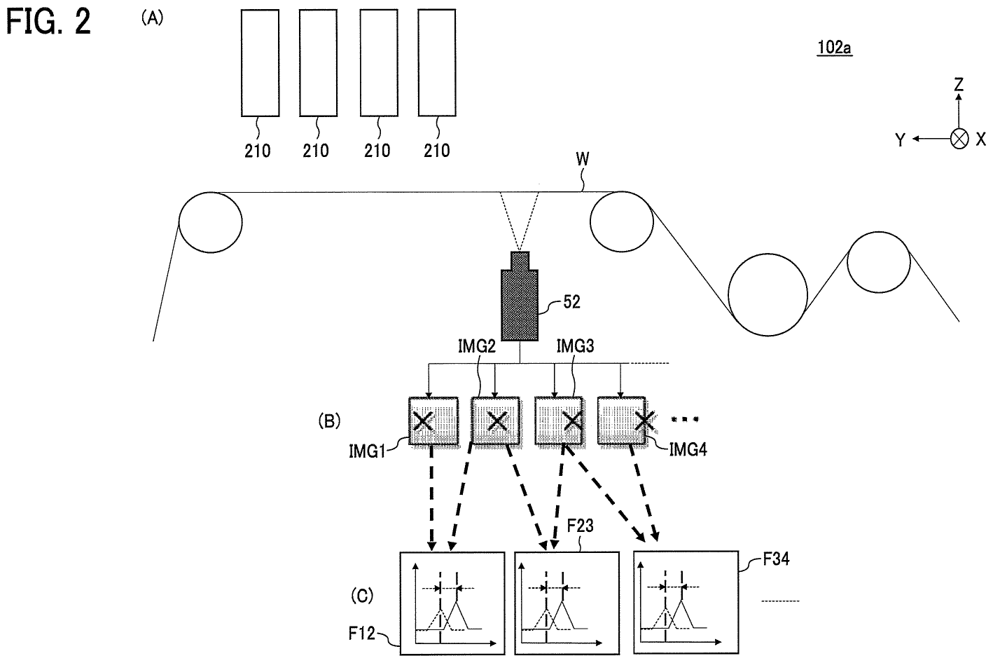

FIG. 2 is a diagram illustrating an example of the configuration of detecting the position of a conveyed object using an image sensor. For example, it is desirable that the droplet discharge apparatus has the following configuration.

As illustrated in part (A) of FIG. 2, the first inkjet printer 102a has a hardware configuration including an image sensor 52.

The image sensor 52 captures an image of a sheet W, which is a conveyed object, to generate image data. Specifically, the image sensor 52 captures an image of a surface portion of the sheet W at a period set in advance.

Part (B) of FIG. 2 is a schematic diagram illustrating a period in which the image sensor 52 captures an image. Hereinafter, the image data will be referred to as “first image data IMG1”, “second image data IMG2”, “third image data IMG3”, “fourth image data IMG4”, . . . in the order of capturing.

Then, the first inkjet printer 102a performs a frequency-analysis process such as fast Fourier transform (FFT) on image data. The first inkjet printer 102a calculates a peak of image correlation between two pieces of image data using the result of the frequency-analysis process.

Part (C) of FIG. 2 is a diagram illustrating an example of the result of frequency analysis. For example, the first inkjet printer 102a generates a first analysis result F12 based on first image data IMG1 and second image data IMG2. Similarly, the first inkjet printer 102a generates a second analysis result F23 based on the second image data IMG2 and third image data IMG3. Subsequently, the first inkjet printer 102a generates a third analysis result F34 based on the third image data IMG3 and fourth image data IMG4. In each analysis result, a peak is calculated.

The first inkjet printer 102a calculates the conveyance amount based on the peak calculated in this manner. For example, the first inkjet printer 102a compares the positions where the peaks occur, to calculate the displacement of a pattern formed on the surface of the sheet W. Based on such a result, the first inkjet printer 102a generates a pulse, for example, each time the feed amount reaches a certain amount.

With such a configuration, similarly to an encoder roller and the like, the first inkjet printer 102a can generate signals indicating the conveyance amount and the like. The configuration in which the position of the sheet W is detected by the image sensor 52 can also reduce an operation of preparing a slit or the like for the sheet W in advance.

Example of Hardware Configuration

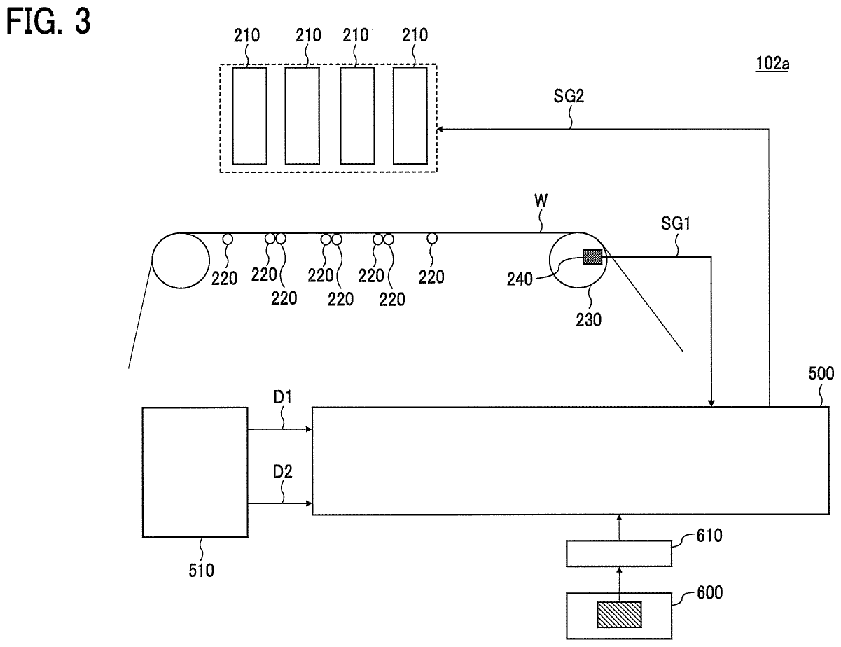

FIG. 3 illustrates an example of the hardware configuration of the droplet discharge apparatus. For example, the first inkjet printer 102a includes devices used for conveyance such as driven rollers 220 and a conveyance roller 230. As illustrated in FIG. 3, the driven rollers 220 are disposed in a manner such that two of the driven rollers 220 sandwich the position at which each print head 210 performs processing. For example, in FIG. 3, two driven rollers 220 are disposed symmetrically with respect to one print head 210. Such arrangement of the driven rollers 220 can restrain fluttering of the sheet W.

For example, an encoder 240 is provided on the conveyance roller 230. The encoder 240 outputs the results of detection as encoder signals SG1.

A control device 500 and a controller 510 are, for example, devices including an arithmetic device, a control device, an input device, an output device, a storage device, and the like. Specifically, the control device 500 and the controller 510 are electronic circuits or the like. The control device 500 and the controller 510 perform predetermined processing on input data.

The first inkjet printer 102a forms an image on the sheet W. The image is indicated by image data D1 or the like transmitted from the controller 510 to the control device 500. The control device 500 calculates a discharge timing at which each print head 210 as a discharge device discharges ink based on the image data D1. The discharge timing is transmitted to each print head 210 in the form of, for example, a control signal indicating the discharge timing (hereinafter referred to as “discharge timing signal SG2”).

The control device 500 calculates the discharge timing in consideration of the detection result by the encoder 240, the landing position, and other factors. Examples of such factors include the accuracy of assembling the print heads 210. Accordingly, the actual landing position may deviate from the target position. The control device 500 corrects the discharge timing so that the actual landing position approaches the target position.

The correction is performed using, for example, a test chart 600 in which an image of a test pattern is formed on a recording medium. The test pattern is, for example, an image indicating a shape set in advance. The test chart 600 is manufactured for calculation of, for example, a correction amount in a so-called adjustment stage prior to actual image formation.

The first inkjet printer 102a includes, for example, a camera 610. The camera 610 as a measuring device captures an image of the test chart 600. As described above, when the test chart 600 is captured, the control device 500 can measure how much deviation has occurred with respect to the target position. Thus, the control device 500 can calculate the correction amount for reducing the deviation based on the capturing result of the test chart 600. The control device 500 also stores the correction amount in the storage device. For example, the correction amount is stored as follows.

TABLE 1

| | | | | | Correction |
|---|---|---|---|---|---|
| | Adjustment | | Printing | | amount |
| Sheet basis weight | 127.9 | g/m² | 90 | g/m² | −10% |
| Sheet width | 765 | mm | 625 | mm | +15% |
| Print density | 50% | | 80% | | +20% |
| Conveyance speed | V | mm/s | (V + 100) | mm/s | −1% |

| | | | |
|---|---|---|---|
| Type of droplet | A | B | +3% |
| Use of pre-coating | Yes | No | −5% |
| liquid | | | |

As illustrated in Table 1 above, the “correction amount” is stored for each condition. For example, in the example of the form illustrated in Table 1 above, the “correction amount” indicates a correction amount for correcting the discharge timing. Therefore, the “correction amount” is a calculation result based on a test chart or the like.

Table 1 above represents an example in which “correction amounts” are stored in association with conditions under which the “correction amount” are calculated. Furthermore, as illustrated in Table 1 above, the conditions include, for example, the type, size, weight, weight per unit area, dimension, and conveyance speed of recording medium, droplet density, droplet type, droplet viscosity, presence or absence of predetermined processing on recording medium, distance between discharge unit and recording medium, type of image formed by droplets, thickness of recording medium, Young's modulus of recording medium, type of apparatus used in the past, whether double-sided processing is performed, or a combination thereof.

The conditions are set based on the printing condition data D2 transmitted from the controller 510.

The conditions may include items other than those described above. The conditions may be a combination of a plurality of items. For example, the conditions may be a combination of the “type of recording medium” and the “type of droplet”.

The example of the format illustrated in Table 1 is also an example of separately storing in which stage of the “adjustment” stage or the “printing” stage the “correction amount” is calculated.

In the example illustrated in Table 1 above, the conditions are “sheet basis weight”, “sheet width”, “print density”, “conveyance speed”, “type of droplet”, and “use of pre-coating liquid”.

As described above, the conditions are items indicating the execution environment of process, characteristics of recording medium, and the like for a process of discharging liquid droplets (including, e.g., a process such as image formation as “actual processing” and “adjustment” performed in advance).

The “sheet basis weight” is a weight per square meter of the recording medium (in units of, for example, “g/m²”). For example, the weight or the weight per unit area is set in a format such as “sheet basis weight”. The weight or the weight per unit area may be set in a form other than the weight per square meter of the recording medium. For example, the weight may be a weight (in units of, e.g., “g”) of the recording medium per one sheet or a predetermined number of sheets.

The “sheet width” is a dimension (in units of, e.g., “millimeters (mm)”) in a width direction (e.g., the X direction in the example illustrated in FIG. 1) of the recording medium. As described above, for example, a dimension in a predetermined direction such as “sheet width” is set as one of the conditions. As the condition, for example, a size determined by a standard or the like, such as “A4”, may be set.

The “print density” is a ratio of droplets discharged per unit length (in units of, e.g., “%”) in the case where an image forming process is performed by discharging liquid droplets. For example, the density of droplets is set in a format such as “print density”. The density of droplets may be a resolution (in units of, e.g., “dot per inch (dpi)” or “dot per mm (dpm)”).

The density of droplets may be determined by the type of an image formed by the droplets. For example, the type of an image formed by droplets is set by distinguishing an image, a solid, a character, or the like. In this example of distinction, the type of image or solid has a high droplet density value. On the other hand, the type of character has a low droplet density value.

In addition, in the case of “adjustment”, since a thin linear figure may be used for a test pattern, the density of droplets may often have a low value. On the other hand, in the case of “printing”, since an image is formed, the density of droplets may often have a high value. As described above, in the cases of “adjustment” and “printing”, the conditions such as the density of droplets may be largely different. Accordingly, the conditions of “adjustment” and “printing” are different, and the correction amounts may be largely different.

Therefore, when the test chart is manufactured for each variation in which the density of droplets is different and the correction amount is calculated for each density of droplets, the droplet discharge apparatus can accurately calculate the correction amount.

The “conveyance speed” is a speed (in units of, e.g., “mm/s”) at which a recording medium is conveyed. The example illustrated in Table 1 above is an example in which the conveyance speed in “adjustment” is set to “V” (which is a reference conveyance speed). On the other hand, in the example illustrated in Table 1, the conveyance speed in “printing” is increased by “+100” compared to “adjustment”.

The “type of droplet” indicates a material, viscosity, or the like of the droplet. For example, as the “type of droplet”, a name of droplet, a material name, or the like is set like “A” or “B”. As the “type of droplet”, for example, a model number or an identification number may be set.

The “use of pre-coating liquid” indicates whether a process of applying a liquid other than ink (hereinafter referred to as a “pre-coating liquid”) to a recording medium is performed before an image forming process is performed. In the case of performing a pretreatment for applying the pre-coating liquid, for example, the amount of the pre-coating liquid applied may be set as one of the conditions. For example, in a case where “use of pre-coating liquid” is “YES”, the droplet discharge apparatus performs image formation on a recording medium after the treatment-liquid applying apparatus 101 performs the process of applying the pre-coating liquid to the recording medium. On the other hand, in a case where the “use of pre-coating liquid” is “NO”, there is no process of applying the pre-coating liquid, and the droplet discharge apparatus performs image formation on the recording medium.

Note that it is desirable that the conditions include the density of droplets, the type of recording medium, the type of droplets, or a combination of the type of recording medium and the type of droplets. In other words, it is desirable that the conditions include conditions that have a large influence on the amount of expansion and contraction of the recording medium, such as the density of droplets, the type of recording medium, the type of droplets, or a combination of the type of recording medium and the type of droplets.

Specifically, in the example illustrated in Table 1, the type of recording medium is set by “sheet basis weight” and “sheet width”. Similarly, in the example illustrated in Table 1 above, the density of droplets is set by “print density”. As indicated by the “correction amount” in Table 1, the “correction amount” of these items may often be “±10%” or more. In this way, it is desirable to store conditions under which the “correction amount” tends to be a large value. In other words, it is desirable that an item having a large influence in which the absolute value of the “correction amount” is “10%” or more is included in the conditions. As described above, when the correction is performed with the setting of a condition having a large influence, the correction can be performed with high accuracy.

The type of recording medium is, for example, a condition for specifying a material or the like of a recording medium. Specifically, the type of recording medium is an item to be set to, for example, “standard paper”, “coated paper”, or the like. Note that, as the type of recording medium, an item other than the material, such as size, dimension, weight, thickness, or Young's modulus may also be specified at the same time. For example, the type of recording medium may be a type name or the like determined by a standard or the like.

When a recording medium expands, a position (target position) on the recording medium to which a droplet is to be discharged is delayed from reaching a position (for example, immediately below the print head 210) at which discharge is actually performed. That is, the elongation of the recording medium is likely to shift the position at which the droplet is discharged. Similarly, when the recording medium contracts, the position on the recording medium to which a droplet is to be discharged reaches the position at which discharge is actually performed earlier.

As the amount of expansion or contraction increases, such a deviation is likely to increase. Accordingly, the correction amount is likely to be a large value to correct a large deviation. Therefore, when a correction amount is determined by specifying a condition in which the amount of expansion and contraction often changes greatly when the condition is changed, the correction amount can be specified with high accuracy. As described above, if the correction amount can be specified with high accuracy, the image quality can be enhanced when the image forming process is performed.

When the conditions are different, for example, the degree of expansion of a recording medium is different. Therefore, when a condition having a large influence on the amount of expansion and contraction of the recording medium is changed, the correction amount may be greatly different.

On the other hand, the correction amount may often be affected by factors other than expansion and contraction of the recording medium. Therefore, the correction amount is not limited to a correction amount calculated in consideration of only the amount of expansion and contraction, and it is desirable to calculate the correction amount in consideration of other influences in a comprehensive manner. That is, it is desirable that the droplet discharge apparatus performs the calculation in consideration of conditions other than the amount of expansion and contraction, such as the environment in which droplets are discharged.

Therefore, it is desirable that the conditions include the Young's modulus of the recording medium. Young's modulus may often have a large influence on the amount of expansion and contraction of the recording medium. Therefore, if the Young's modulus can be specified according to the conditions, the amount of expansion and contraction can be specified with high accuracy. Note that the Young's modulus is not limited to a form in which a value is directly set, and may be determined from a material or the like.

It is desirable that the conditions include devices used in the past and the like. In many cases, there are unique characteristics for each apparatus. That is, a certain bias or the like may occur depending on each apparatus. Therefore, it is desirable to set, as a condition, the models of apparatuses used in the past or information for identifying each apparatus. When such information is set as a condition, the correction can be performed with high accuracy in consideration of characteristics of each apparatus.

It is also desirable that the conditions include whether double-sided processing is performed. In addition, in the case of performing double-sided processing, it is desirable to further set which of the front side and the back side is to be processed in the conditions.

In double-sided processing, for example, processing is performed in the order of a first apparatus (for example, the first inkjet printer 102a in the configuration illustrated in FIG. 1) and a second apparatus (for example, the second inkjet printer 102b in the configuration illustrated in FIG. 1). That is, the first apparatus performs image formation on the front side. Then, the second apparatus forms an image on the back side.

In the processing on the front side, drying processing or the like may be performed. Then, processing is performed on the back side. Accordingly, the front side and the back side may often have different amounts of expansion and contraction due to drying or the like. Therefore, in the conditions, it is desirable to specify whether double-sided processing is to be performed and which side of the double-sided processing is to be processed. When such information is set as a condition, the correction can be performed with higher accuracy.

When the correction is performed based on the correction amount that matches the condition, the discharge timing can be corrected with high accuracy. In addition, the correction amount is stored for each condition when the correction amount is calculated, thus allowing a reduction in adjustment work such as calculation of the correction amount every time the condition is changed.

Note that the hardware configuration is not limited to the configuration illustrated in FIG. 3. That is, in an embodiment, the droplet discharge apparatus may have a hardware configuration including devices other than the devices illustrated in FIG. 3.

Example of Overall Processing

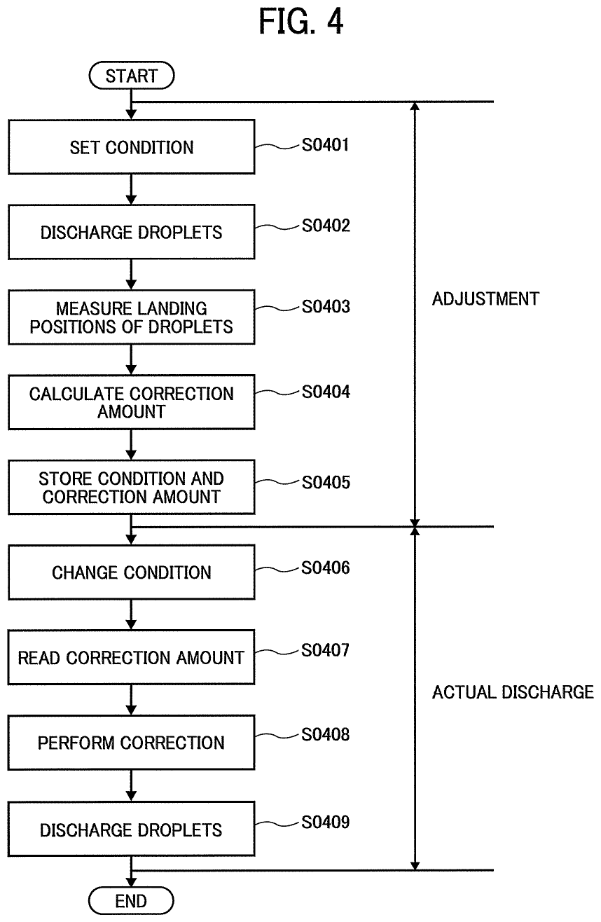

FIG. 4 is a diagram illustrating an example of overall processing. In the example described below, the overall processing sequentially executes a process of “adjustment” and a process of “actual processing”.

“Adjustment” is a process of creating a test chart and calculating and storing a correction amount using the test chart. After the “adjustment”, in the “actual processing”, the droplet discharge apparatus corrects the timing of discharging droplets in a process of discharging droplets such as image formation based on the correction amount set in the “adjustment”.

In step S0401, the droplet discharge apparatus sets a condition. That is, the droplet discharge apparatus sets a condition for which a correction amount is to be calculated in a later stage. Therefore, the subsequent processing performed in the “adjustment” is executed under the conditions set in step S0401.

In step S0402, the droplet discharge apparatus discharges droplets. Thus, the test chart is created in step S0402.

In step S0403, the droplet discharge apparatus measures the landing position. That is, the step S0403 measures the landing positions of droplets discharged in step S0402.

In step S0404, the droplet discharge apparatus calculates correction amounts. That is, in step S0404, the correction amounts are calculated for the conditions set in step S0403, based on the measurement result in step S0401.

In step S0405, the droplet discharge apparatus stores the conditions and the correction amounts. That is, the droplet discharge apparatus stores the calculation results of step S0404. When the calculation results are stored in this manner, the droplet discharge apparatus can store the correction amount for each condition as illustrated in Table 1 above.

Note that, in order to store the correction amounts under a plurality of conditions, the droplet discharge apparatus may repeatedly execute “adjustment” under different conditions.

After the process of “adjustment” is executed as described above, the droplet discharge apparatus performs the process of “actual processing” in the following procedure, for example.

In step S0406, the droplet discharge apparatus changes the conditions. In other words, in step S0406, the droplet discharge apparatus sets the conditions for “actual processing”. The conditions under which image formation is performed are determined by the specifications of image formation and the like.

In step S0407, the droplet discharge apparatus reads out the correction amount. That is, in step S0407, the droplet discharge apparatus searches a database or the like that stores, in step S0405, the same conditions as the conditions set in step S0406. Then, the droplet discharge apparatus reads out correction amounts that matches the conditions of “actual processing”.

In step S0408, the droplet discharge apparatus performs correction. That is, in step S0408, the droplet discharge apparatus corrects the discharge timing, based on the correction amount read out in step S0407, to correct the landing position.

In step S0409, the droplet discharge apparatus performs discharge. That is, in step S0409, the droplet discharge apparatus discharges droplets in a state in which the correction in step S0408 has been performed.

As described above, in the process of “actual processing”, processing such as image processing is performed by adapting the correction amount stored in “adjustment”.

The overall processing is not limited to the procedure illustrated in FIG. 4. For example, the timing at which “adjustment” is executed may be prior to “actual processing”. That is, “adjustment” may not be executed continuously with “actual processing” as long as “adjustment” is executed in advance. In addition, a part of the overall processing may be executed in parallel, in a distributed manner, or in a redundant manner.

Functional Configuration

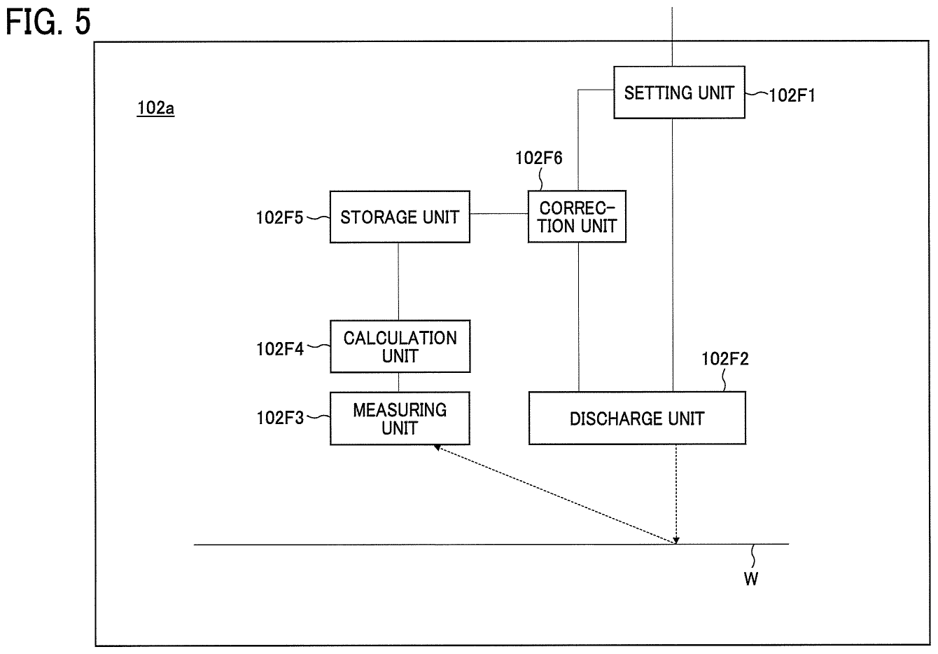

FIG. 5 is a diagram illustrating an example of the functional configuration. For example, the droplet discharge apparatus has a functional configuration including a setting unit 102F1, a discharge unit 102F2, a measuring unit 102F3, a calculation unit 102F4, a storage unit 102F5, and a correction unit 102F6.

The setting unit 102F1 performs a setting procedure for setting conditions for a recording medium or processing using droplets. For example, the setting unit 102F1 is implemented by the control device 500 or the like.

The discharge unit 102F2 performs a discharge procedure to discharge droplets onto a recording medium. For example, the discharge unit 102F2 is implemented by the print heads 210.

The measuring unit 102F3 performs a measurement procedure for measuring the landing positions of droplets having landed on the recording medium. For example, the measuring unit 102F3 is implemented by the camera 610.

The calculation unit 102F4 performs a calculating procedure for calculating a correction amount, based on the landing positions. For example, the calculation unit 102F4 is implemented by the control device 500.

The storage unit 102F5 performs a storage procedure for storing the correction amount for each condition. For example, the storage unit 102F5 is implemented by the control device 500.

The correction unit 102F6 performs a correction procedure for correcting the landing positions by correcting the timing at which the discharge unit 102F2 performs discharge with a correction amount that matches the condition. For example, the correction unit 102F6 is implemented by the control device 500.

As described above, in the configuration in which the correction amount is stored for each condition, even if a condition is changed, the correction amount for the condition can be specified as long as the correction amount for the condition has been previously calculated. Therefore, the work of creating and adjusting the test chart for calculating the correction amount again can be omitted.

Example of Correction Based on Encoder Signal

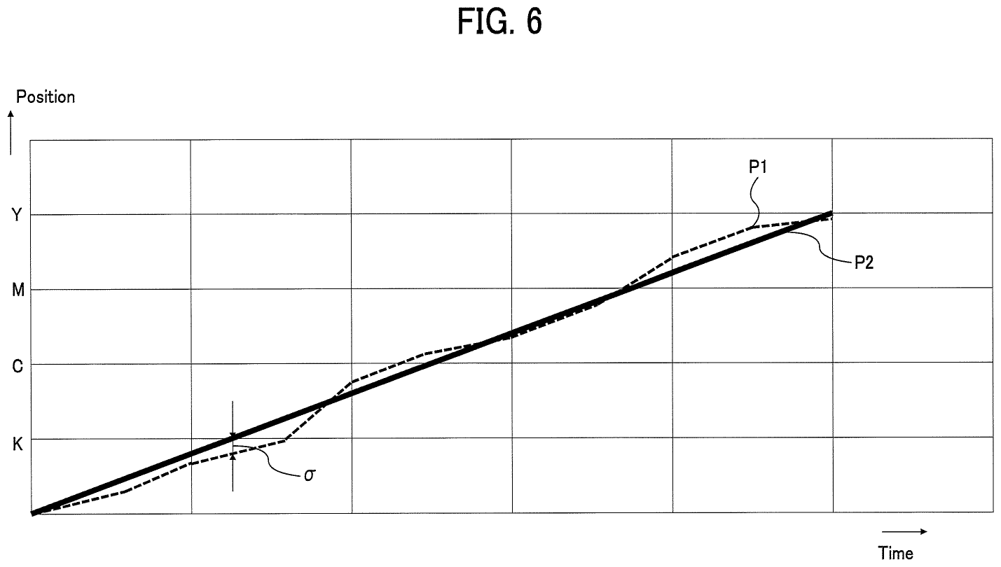

FIG. 6 is a diagram illustrating an example of correction based on an encoder signal. In FIG. 6, the horizontal axis represents time in conveyance. On the other hand, in FIG. 6, the vertical axis indicates the position of the recording medium. Note that “Y” indicates a position where discharge is performed by a print head 210 that discharges yellow ink (for example, a position directly below the print head 210). Similarly, “M”, “C”, and “K” indicate positions where discharge is performed by the print heads 20 that discharge magenta, cyan, and black ink. As described above, the droplet discharge apparatus discharges, for example, four colors of ink to form a color image.

For example, each of the print heads 210 is disposed at a position where the distance between the print heads 210 is an integral multiple of the conveyance roller 230. Such a position can a deviation due to the eccentricity of the conveyance roller 230.

The encoder signal SG1 indicates a detection result of the encoder 240 at, for example, a detection position P2. For example, in a case where a recording medium is conveyed using a rotating body such as the conveyance roller 230, the encoder 240 which is an example of a detector detects the rotation amount of the rotating body. For example, the conveyance roller 230 is divided into equal areas at a predetermined angle in advance. The encoder 240 outputs a signal based on the encoder signal SG1 each time the conveyance roller 230 rotates by a predetermined angle.

On the other hand, an actual recording medium is conveyed to a position such as an actual position P1 illustrated in FIG. 6. That is, a deviation (hereinafter, the amount of deviation between the actual position P1 and the detected position P2 is referred to as “deviation amount σ”) occurs between the actual position P1 and the detected position P2.

For example, the deviation amount σ occurs due to factors such as thermal expansion of the conveyance roller 230, slippage between the recording medium and the conveyance roller 230, and expansion of the recording medium. As described above, since the deviation amount σ or the like occurs with respect to the position indicated by the encoder signal SG1, the landing position may deviate from the target position in the case of discharge based on only the encoder signal SG1. On the other hand, if the rotation amount of the rotating body, that is, the deviation amount σ with reference to the detection position P2 can be corrected, droplets can be landed on the target positions with high accuracy.

Therefore, when the test chart is created and the deviation amount σ is corrected to be small, the droplet discharge apparatus can accurately land droplets on the target positions.

### Comparative Example

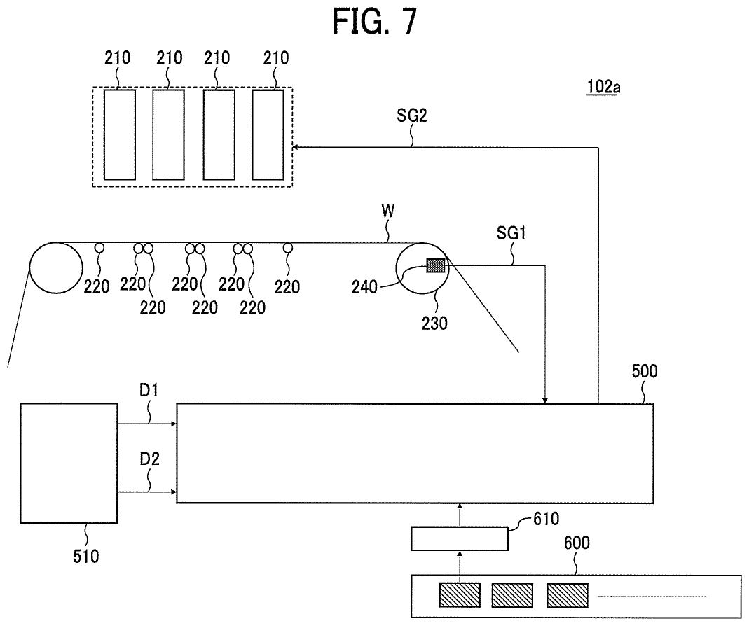

FIG. 7 is a diagram illustrating a comparative example. Compared with FIG. 3, the comparative example described below is different in that the test chart 600 is created each time the conditions are changed.

In the comparative example, the correction amount is not stored for each condition. For this reason, in the comparative example, when conditions such as the type of recording medium, the density of droplets, the conveyance speed, the distance between the print head and the recording medium, or the type of droplets are changed, the test chart 600 is created and the correction amount is calculated for each change. Therefore, in the comparative example, the load of adjustment occurs every time the conditions are changed, and there are many operations such as adjustment.

### Other Embodiment

The droplet discharge apparatus may be a single apparatus or a combination of a plurality of apparatuses.

The droplet discharge apparatus may perform a process other than image formation on a recording medium by discharging droplets of a liquid other than ink.

The recording medium may also be, for example, a continuous form, which may be referred to as “continuous form sheet”, “continuous paper”, “LP paper”, “form paper”, “fanfold paper”, or the like). Note that the continuous form may be a so-called “Z paper”. Further, the recording medium is not limited to roll paper, and may be cut paper or the like.

In addition to plain sheet of paper, examples of the recording medium include, but are not limited to, coated paper, label paper, an overhead projector sheet, a film, and a flexible thin plate.

In other words, the recording medium (or a recording medium that is used for an inkjet image forming apparatus) is made of a material to which droplets of liquid are at least temporarily adherable, a material to which droplets adheres and fixes, or a material to which droplets adheres and permeate. Specific examples of a recording material or formation made of such a material include, but are not limited to, a recording medium such as a sheet, a film, or cloth, an electronic component such as an electronic substrate or a piezoelectric element (which may be referred to as a piezoelectric component), layered powder, an organ model, and a testing cell.

In short, the recording medium is made of any material to which droplets are adherable, such as paper, thread, fiber, fabric, leather, metal, plastic, glass, wood, ceramic, or a combination thereof.

The correction method may be implemented by a program or the like, for example. That is, the correction method may be executed by causing an arithmetic device, a storage device, an input device, an output device, and a control device to operate in cooperation with each other based on a program.

Embodiments of the present disclosure are not limited to the above-described embodiments, and various modifications can be made without departing from the technical scope of the present disclosure. It is therefore to be understood that the disclosure of the present specification may be practiced otherwise by those skilled in the art than as specifically described herein. Such embodiments and variations thereof are included in the scope and gist of the embodiments of the present disclosure and are included in the embodiments described in claims and the equivalent scope thereof.

1. A droplet discharge apparatus, comprising:
a control device configured to set conditions for a recording medium or a process using droplets;
a discharge device configured to discharge the droplets onto the recording medium; and
a measuring device configured to measure landing positions of the droplets on the recording medium,
the control device configured to:
calculate a correction amount based on the landing positions;
store the correction amount for each of the conditions; and
correct a timing at which the discharge device performs discharge with correction amounts that match the conditions, to correct the landing positions.

2. The droplet discharge apparatus according to claim 1,
wherein the conditions include at least one of: a type, a size, a weight, a weight per unit area, a dimension, and a speed of the recording medium, a density of the droplets, a type of the droplets, a viscosity of the droplets, presence or absence of predetermined processing on the recording medium, a distance between the discharge device and the recording medium, a type of an image formed by the droplets, a thickness of the recording medium, a Young's modulus of the recording medium, a device used in past, double-sided processing, and a combination thereof

3. The droplet discharge apparatus according to claim 1,
wherein the discharge device is configured to discharge droplets for each of the conditions to form an image of a test pattern on the recording medium to create a test chart,
wherein the control device is configured to calculate the correction amount based on an amount of deviation specified by the test chart, and
wherein the control device is configured to store the correction amount for each of the conditions.

4. The droplet discharge apparatus according to claim 3, further comprising:
a rotating body configured to convey the recording medium; and
a detector configured to detect a rotation amount of the rotating body,
wherein the control device is configured to calculate the correction amount, based on the amount of deviation from a position based on the rotation amount.

5. The droplet discharge apparatus according to claim 4,
wherein the rotating body includes a conveyance roller, and
wherein the detector includes an encoder.

6. The droplet discharge apparatus according to claim 1,
wherein the discharge device includes a print head.

7. The droplet discharge apparatus according to claim 1,
wherein the measuring device includes a camera.

8. A correction method to be performed by a droplet discharge apparatus, the correction method comprising:
setting conditions for a recording medium or a process using droplets;
discharging the droplets onto the recording medium;
measuring landing positions of the droplets on the recording medium;
calculating a correction amount based on the landing positions;
storing the correction amount for each of the conditions; and
correcting a timing of discharging the droplets with correction amounts that match the conditions, to correct the landing positions.
